(19) United States
(12) Patent Application Publication
(10) Pub. No.: US 2004/0168174 A1
(43) Pub. Date: Aug. 26, 2004

(54) System for object cloing and state synchronization across a network node tree

(76) Inventor: Tyler Foley Baker, Columbus, OH (US)

Correspondence Address: JEFFREY FURR, 253 N. MAIN STREET, JOHNSTOWN, OH, 43031, US

(21) Appl. No.: 10/708,646

(22) Filed: Mar. 17, 2004

Related U.S. Application Data
(63) Continuation-in-part of application No. 09/520,588, filed on Mar. 8, 2000.

(51) Int. Cl. G06F 13/00

(52) U.S. Cl. 719/310

(57) ABSTRACT

The invention is a network node tree where a root node computer at the top of the network node tree has one or more branch node computers or leaf node computers maintaining a network connection to it at any given time. Each branch node computer may have one or more branch node computers or leaf node computers maintaining a network connection to it at any given time, thereby forming a network node tree starting at the top with the root node computer. In the network node tree a set of distributable objects, whose origination resides on the root node computer, are cloned and dispatched to descendant branch node computers and descendant leaf node computers. If a change is made to the “state” of a distributable object on the root node computer, that change is reflected throughout the entire network node tree to the corresponding cloned distributable object residing on each descendant branch node computer and descendant leaf node computer.

### CROSS REFERENCE TO RELATED APPLICATIONS

This is a Continuation-in-part of Application Ser. No. 09/520,588.

### BACKGROUND OF INVENTION

1. Field of the Invention

This invention relates to the art of distributed object messaging systems, and more specifically a system where a root node computer at the top of the network node tree has one or more branch node computers or leaf node computers maintaining a network connection to it at any given time.

2. Description of Prior Art

The current method to perform object messaging is done through such messagingstandards like CORBA and DCOM where the methods (AKA remote procedures) executed on objects are done through an interface that acts on these objects, each residing at a remote location. The distributed object messaging is done through the use of a server hosting an object where any mutations of that object are executed via the interface implementation of the calling client. The data variables of the remote object are made available to the client by a symbolic reference of the remote object which usually has these data variables cached in some way. An actual true copy of the remote object is never made available to the client and the implementation of the remote object is never made directly available to the client as well.

This system is not suitable to an environment in which clients need to have true copies of the remote object residing on their machines at any given time. A true copy of a remote object is needed in case the client wished to save the object into a persistent form, or else for allowing a client application that needs to make client side mutations to the object which are not reflected on the host object.

With the advent of the computer society, and the need for reliable client internet applications whose functionality is not totally dependent upon interaction with a centralized server through the unreliable worldwide computer network known as the Internet, the need for an object messaging system using true cloned objects whose functionality is not completely bound to the reliability of the network is needed.

The prior art while providing an interface for clients to access the data representation of a remote object, it does not provide a real object for the client to manipulate on the client. If the network connection that facilitates communication between the client and the server where the remote object resides ceases, then the ability to manipulate that object ceases. Also, since the remote object is actually located on a server, then serialization of that object's complete state cannot occur as the implementation for creating that object also resides on the server. In effect if the network fails, then the client application may completely fail. Last but not least, the concept of working “offline” with an object is not possible as a network connection needs to be present for the client to interact with the remote object on the server. Considering the unreliable nature of the internet network, the quality of the systems which use the prior art are limited to the quality of their network connection which in many cases is not reliable. This invention differs from the prior art as the objects are cloned and kept in sync with the original object that was cloned and from the root node server. The functionality of the cloned object on the client is not impeded if the network connection between the remote server and the client ends because an independent object resides on the client. This allows an application to continue operation using the cloned object copy even after a session with the root node server has been terminated. Using this invention allows client applications to have all of the distributed object synchronization benefits of the prior art, yet distributed objects on the client may act independently of the original remote object's state if they choose, because they are true copies and not just proxy objects of the remote object.

There is still room for improvement in the art.

### SUMMARY OF INVENTION

An object of the present invention is to provide an inexpensive, less intrusive, easier and efficient way to perform distributed object messaging while distributed objects on the client may act independently of the original remote object's state if they choose, because they are true copies and not just proxy objects of the remote object. Much of the distributed object messaging is done through the internet with numerous users attempting to communicate with each other and to share documents and files in a real-time environment.

The present invention has a network node tree where a root node computer at the top of the network node tree has one or more branch node computers or leaf node computers maintaining a network connection to it at any given time. In addition, each branch node computer may have one or more branch node computers or leaf node computers maintaining a network connection to it at any given time; thereby forming a network node tree starting at the top with the root node computer. This system eliminates the need for a centralized server or servers.

In the network node tree a set of distributable objects, whose origination resides on the root node computer, are cloned and dispatched to descendant branch node computers and descendant leaf node computers. If a change is made to the “state” of a distributable object on the root node computer, that change is reflected throughout the entire network node tree to the corresponding cloned distributable object residing on each descendant branch node computer and descendant leaf node computer. The maintenance of a distributable object's “state” across all computers in the network node tree is the process of cloned distributable object synchronization.

The system relies upon the distributed synchronization of data across multiple computers. This is different from simple network data propagation in that data is simply not routed or cached from peer to peer on the network, but rather the data objects are processed, validated into a synchronized state on each peer, and then those data object be propagated to other peers if the state of the data objects is the same as the original host. What is important about this claim is that a new peer connecting to an already existing peer on the network node tree can download the synchronized state of these data objects without having to get that “bootstrap” data from the original host. This is important because it allows for flexible levels of scalability on peer to peer networking systems dealing with synchronized data objects which need to maintain a “cloned state” across all peers connected to the network. This “cloned” state needs to be maintained in real-time with the system while commercial solutions willstore the data into a database and then that data may or may not be transmitted to other clients at any time in a manner similar to how email servers store a user's email until they either download the email off of the server or else explicitly delete the email via an interface to the host computer. This is done invariety of ways but is not relevant to the system patent as the system ensures that the user interface of all clients remain in synchronicity.

This system for object cloning and state synchronization across a network node tree is more efficient, effective, accurate and functional, with less system requirements than the current art.

### BRIEF DESCRIPTION OF DRAWINGS

Without restricting the full scope of this invention, the preferred form of this invention is illustrated in the following drawings:

FIG 1 shows a diagram of the major steps of the invention.

FIG. 2 shows the network node tree hierarchy.

FIG. 3 shows how distributable object being dispatched and cloned throughout the network node tree.

FIG. 4 shows how client nodes are moved on the network node tree by the connection tree manager.

FIG. 5 shows how distributable objects are encapsulated in an object entry descriptor.

FIG. 6 gives a flowchart of the Authentication and Registration process.

FIG. 7 shows the Connection and Protocol Negotiation process.

### DETAILED DESCRIPTION

The system relies upon the distributed synchronization of data across multiple computers. This is different from simple network data propagation in that data is simply not routed or cached from peer to peer on the network, but rather the data objects are processed, validated into a synchronized state on each peer, and then those data objects be propagated to other peers if the state of the data objects is the same as the original host. What is important about this claim is that a new peer connecting to an already existing peer on the network node tree can download the synchronized state of these data objects without having to get that “bootstrap” data from the original host. This is important because it allows for flexible levels of scalability on peer to peer networking systems dealing with synchronized data objects which need to maintain a “cloned state” across all peers connected to the network. This “cloned” state needs to be maintained in real-time with the system while commercialsolutions willstore the data into a database and then that data may or may not be transmitted to other clients at any time in a manner similar to how email servers store a user's email until they either download the email off of the server or else explicitly delete the email via an interface to the host computer. This is done invariety of ways but is not relevant to the system patent as the system ensures that the user interface of all clients remain in synchronicity.

The preferred embodiment of the invention is a network node tree 28 which is a computer system where a root node 30 computer at the top of the network node tree 28 has one or more branch node 32 computers or leaf node 34 computers maintaining a network connection to it at any given time. In addition, each branch node 32 computer may have one or more branch node 32 computers or leaf node 34 computers maintaining a network connection 30 to it at any given time, thereby forming a network node tree 28 starting at the top with the root node computer.

In the network node tree 28, a set of distributable objects 36, whose origination resides on the root node 30 computer, are cloned and dispatched to descendant branch node 32 computers and descendant leaf node 34 computers. If a change is made to the “state” of a distributable object 36 on the root node computer, that change is reflected throughout the entire network node tree 28 to the corresponding cloned distributable object 36 residing on each descendant branch node 32 computer and descendant leaf node 34 computer. The maintenance of a distributable object's “state” across all computers in the network node tree 28 is the process of cloned distributable object synchronization 24.

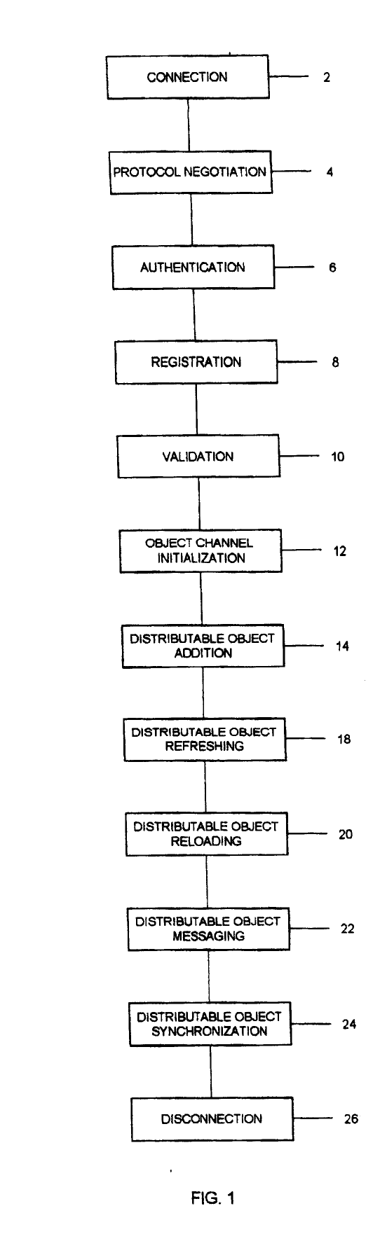

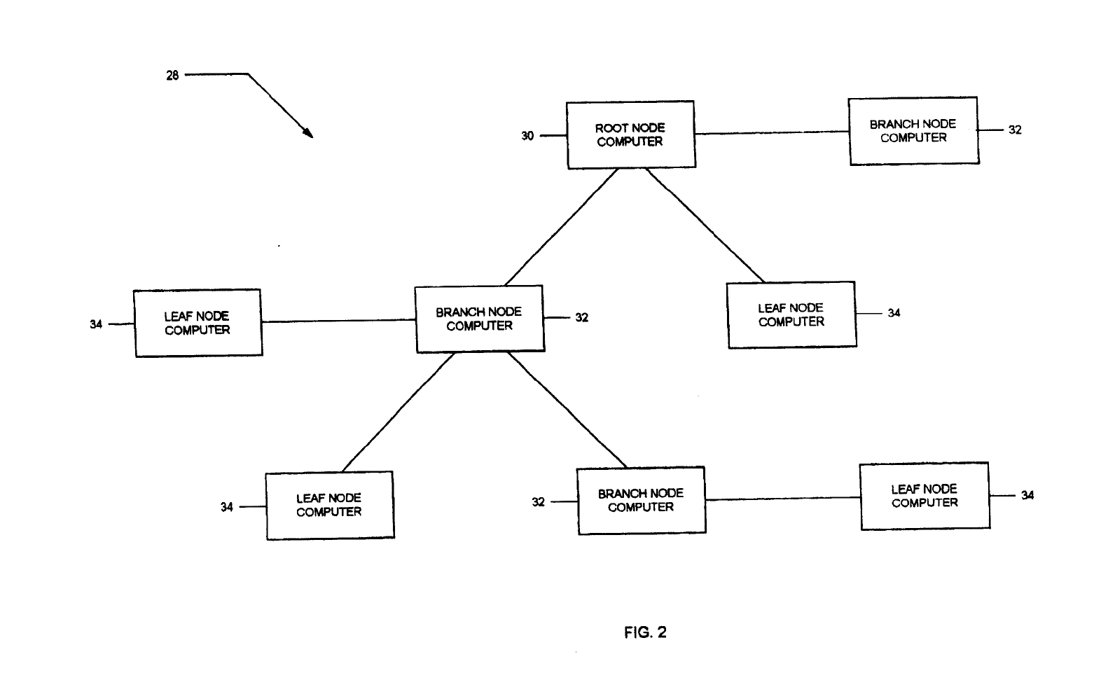

In a system for object cloning and state synchronization across a network node tree 28 a root-server 30 and a branch 32 or leaf node(s) 34 involves the following events as shown in FIG. 1 with a network node tree 28 as shown in FIG. 2:1. Connection 2,2. Protocol Negotiation 4,3. Authentication 6,4. Registration 8,5. Validation 10,6. Object Channel Initialization 12,7. Distributable Object Addition 14,8. Distributable Object Refreshing 18,9. Distributable Object Reloading 20,10. Distributable Object Messaging 22,11. Distributable Object Synchronization 24,12. Disconnection 6.

Connection 2, the first step with the invention, involves creation of the root server 30. The root server 30 first binds itself to some form of I/O channel which is usually in the form of a TCP/IP Socket. This I/O channel is the connection point where clients and branch node 32s connect to the root server 30.

A branch node 32 first makes an I/O connection to the root server 30 and then proceeds to bind itself to some form of I/O channel for clients and other root servers 30 to connect to. A client simply makes a connection 2 to the root node 30.

Protocol Negotiation 4 is the process where the root server 30 sends the branch node 32 or client the authentication interface 54 in the form of executable contact for use in generating some form of authentication data 56 to identify a particular client. In addition, if a message processor is used to post-process messages that flow through the object channel, then the root server 30 negotiates the message processor with the branch 32 or leaf node 34.

Authentication 6 with the root server 30 is the process of taking the generated authentication data 56 from the authentication interface 54 such as a user name and password, and attempting to register the connecting client with the object channel registry. If the action of registration 8 is granted by the object channel registry, then the client is either directly added to the root node 30 server or else is commanded to reconnect to another branch node 32 computer in the network node tree 28.

Validation 10 is the process that occurs after a client has been authenticated. The client is given a token which is used to reconnect to another branch node 32 or for use in maintaining a connection to the root server 30.

Object Channel Initialization 12 is the process of a branch node 32 computer or leaf node 34 computer being initialized with the a cloned security controller 46 from the root node 30 server, as well as cloned copies of all of the distributable objects 36 that reside on the root node 30 server.

Distributable Object Addition 14 is the addition of a distributable object 36 from any node computer in the network node tree 28 to the root node 30 server. This added object is then cloned and redispatched for addition to each branch node 32 and leaf node computer in the network node tree 28.

Distributable Object Refreshing 18 is the refreshing of a distributable object 36 by the branch nodes 32 or leaf nodes 34 from the root server 30.

Distributable Object Reloading 20 is the reloading of a distributable object 36 by the branch nodes 32 or leaf nodes 34 from the root server 30.

Distributable Object Messaging 22 is the transmitting of distributable object 36 messages across the network node tree 28.

Distributable Object Synchronization 24 is if a change is made to the “state” of a distributable object 36 on the root node computer 30, that change is reflected throughout the entire network node tree 28 to the corresponding cloned distributable object 36 residing on each descendant branch node 32 computer and descendant leaf node 34 computer.

Disconnection 26 is simply the disconnection of a branch 32 or leaf node(s) 34 from the network node tree 28.

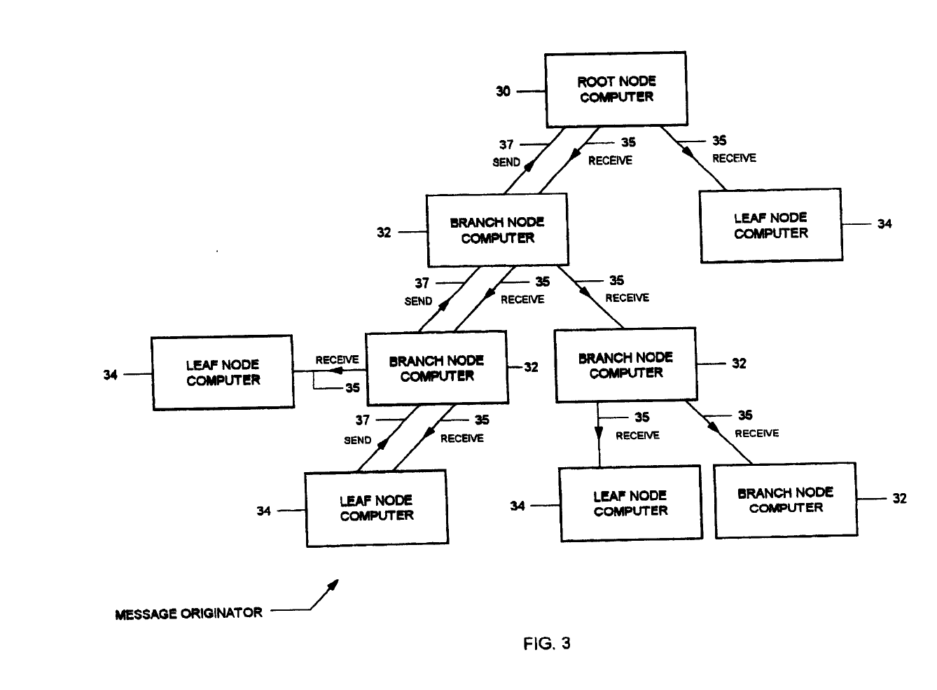

In the network node tree 28, a set of distributable objects 36, whose origination resides on the root node 30 computer, are cloned and dispatched to descendant branch node 32 computers and descendant leaf node 34 computers. This is shown in FIG. 3. If a change is made to the “state” of a distributable object 36 on the root node 30 computer, that change is reflected throughout the entire network node tree 28 to the corresponding cloned distributable object 36 residing on each descendant branch node 32 computer and descendant leaf node 34 computer. The descendant branch node(s) 32 and descendant leaf node(s) 34 received through a receive function 35 from the previous node in the network node tree 28. If a distributive object 36 is changed in either the branch node 32 or leaf node 34 that change is sent utilizing a send function 37 to the previous node up the network node tree 28 to the root node 30 and then sent across the network node tree 28 utilizing the receive function 35. The maintenance of a distributable object's “state” across all computers in the network node tree 28 is the process of cloned distributable object synchronization 24.

The network node tree 28 is first constructed by creating a root node 30 computer. The root node 30 computer is responsible for authentication 6 and registration 8 of branch node 32 computers and leaf node 34 computers. The root node computer is also responsible for the construction of the network node tree 28 so that if a set of branch node 32 computers and leaf node 34 computers join the network node tree 28, they are connected in such a way that network communication between all computers is scaleable for the network environment the network node tree 28 resides in.

The first step in constructing the network node tree 28 is initialization of the root node 30 computer. The root node 30 computer is first initialized with a security controller 46. The implementations specified by the security controller 46 are then dynamically instantiated and loaded into the root node 30 computer's environment.

A security controller is an implementation of a set of abstract interfaces which:—Govern authentication to the root node 20 computer by descendant branch node 32 computers and leaf node 34 computers.

Provide for network communication security between computers in the network node tree 28—Manage the construction and maintenance of the network node tree 28 hierarchy.

After the initialization of the root node 20 computer, branch node 32 computers and leaf node 34 computers may connect to the root node 20 computer for authentication 6 and possible registration with the network node tree 28. If authentication 6 is successful, then the root node 30 computer may instruct the connecting branch node 32 computer or leaf node 34 computer to reconnect to another descendant branch node 32 computer for the purpose of balancing out the connection load across the network node tree 28. Otherwise, the current connection 2 to the root node 30 computer remains and the connecting branch node 32 computer or leaf node 34 computer is registered within the network node tree 28.

Upon connection 2 to a root node 30 computer by a branch node 32 computer or leaf computer or else a connection 2 to a branch node 32 computer by another branch node 32 computer or leaf node 34 computer, the two computers first engage in the process of protocol negotiation 4. Protocol negotiation 4 is the process of the connecting computer first receiving a channel protocol message which contains the security controller used by the computer being connected to. If a message processor exists within the security controller 46, then an instance of that message processor is instantiated for each computer and installed for that particular connection 2. Then the message processor on each computer may generate some form of initialization data that the message processor on the other computer may need to use for proper communication to ensue.

This initialization data may be the binary form of a public key if the message processor elects to encrypt all subsequent messages between the two computers. The initialization data may also be compression and decompression parameters if the message processor elects to compress all subsequent messages exchanged between the two computers, but usually the message processor is used for encryption of messages sent between two computers in the network node tree 28.

Authentication 6 is the process of a branch node 32 computer or leaf node 34 computer making a connection 2 to a root node 30 computer and using the security controller 46 that was created during protocol negotiation 4 to instantiate an authentication interface 54. The authentication interface 54 usually is a graphical interface which gathers user input for authentication purposes. For example, an authentication interface 54 might comprise of a dialog box which has a user name and password field in it. The authentication interface 54 does not need to have a graphical component as it might search a computer's memory for some sort of identifier that can be used for authenticating the computer. Once the authentication data 58 has been generated by the authentication interface, the authentication data 58 is then sent back to the root node 30 computer which then uses an implementation of a registry interface for authenticating the connecting computer.

Registration 8 is the process of formally adding a branch node 32 computer or leaf node 34 computer to the network node tree 28 and notifying all computers within the network node tree 28 that a new computer has been added to the network node tree 28.

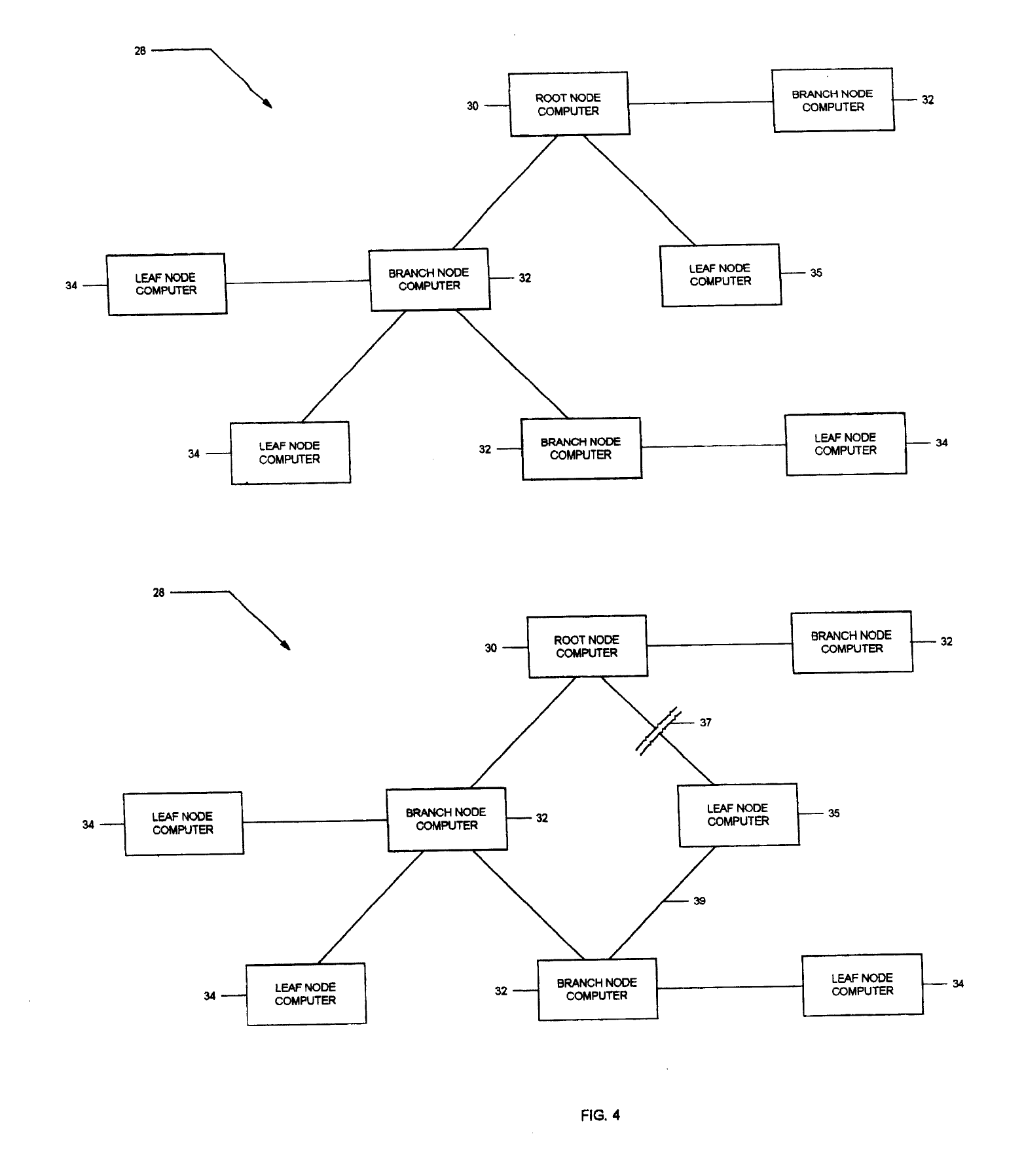

As shown in FIG. 4, following successful authentication 8 of a branch node 32 computer or leaf node 34 computer, the root node 30 computer may instruct the now authenticated computer to terminate the connection to the root node 30 computer and reconnect to another descendant branch node 32 computer. The rules for determining which branch node 32 computers or leaf node 34 computers get reconnected to another branch node 32 computer is determined by an implementation of the connection tree manager 50 interface which is contained within the security controller 46 used by the root node 30 computer. Before termination of the connection to the root node 30 computer occurs, the root node 30 computer generates a special token which is sent to the authenticated computer as well as the branch node 32 computer in the network node tree 28 which the authenticated computer is instructed to reconnect to. The authenticated computer then reconnects to the instructed branch node 32 computer where the authenticated computer presents its token for validation 10 by the branch node 32 computer. If a valid token is found in the token list of the branch node 32 computer, then the authenticated computer becomes validated. Once validation 10 has occurred, the root node 30 computer is notified of the validation and the authenticated computer is formally registered within the network node tree 28.

A connection tree manager 50 manages the network node tree 28 hierarchy in a way which usually results in an optimal network configuration of computers. A connection tree manager 50 may instruct all connecting branch node 32 computers to behave as leaf node 34 computers by forcing all connections to be directly with the root node 30 computer, however, in many cases for the purpose of balancing the load on the network node tree 28, the connection tree manager 50 will often ensure that some branch node 32 computers act as relay stations for descendant branch node 32 computers and leaf node 34 computer.

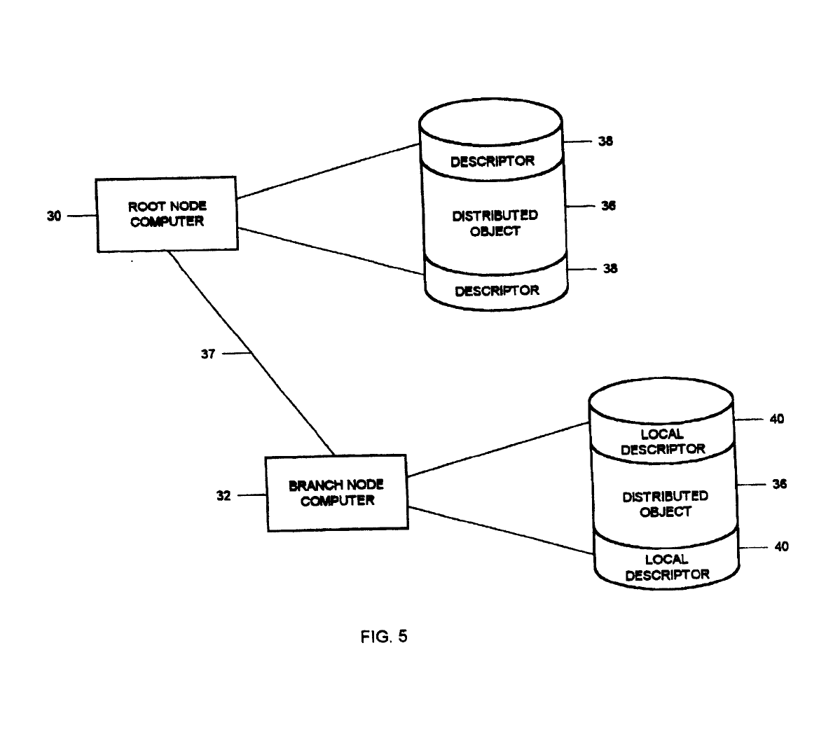

Following initialization of the root node 30 computer, one or more distributable objects 36 may be created and added to the root node 30 computer. As shown in FIG. 5, these distributable objects 36 are encapsulated in an object entry descriptor 38 which contains state maintenance variables as well as information about how to load the distributable object 36 into memory from its serialized form. If a branch node 32 computer or leaf node 34 computer wishes to add a distributable object 36 into the network node tree 28, then the locally accessible distributable object 36 is serialized into a form for transport and sent up the network node tree 28 to the root node 30 computer. Once the root node 30 computer actually receives the serialized copy of the distributable object 36, the distributable object 36 is then instantiated from its serialized form and added to the network node tree 28 and encapsulated in an object entry descriptor 38. Finally, the serialized form of the distributable object 36 is then dispatched to all descendant branch node 32 computers and leaf node 34 computers in the network node tree 28. Once each branch node 32 computer and leaf node 34 computer receives the serialized form of the distributable object 36, the distributable object 36 is instantiated from its serialized form as a cloned copy of the original distributable object 36 residing on the root node 30 computer and encapsulated by a local object entry descriptor 40.

A distributable object 36 is an object which is serializable into some persistent state which can then be replicated into another object instance in the same state. A distributable object 36 also implements interfaces that are used for determining how the said distributable object 36 should operate in the network node tree 28. An object entry descriptor 38 encloses each distributable object 36 to act as an interface for sending messages to other cloned copies of the distributable object 36 in the network node tree 28. Finally, a distributable object 36 is responsible for handling the contents of received object update messages.

A change or mutation to an object on the root node 30 computer from an action originating on the root node 30 computer will trigger the synchronization process of maintaining object state across all cloned objects in the network node tree 28. If a change to the “state” of a cloned object on one of the descendant branch node 32 computers or leaf node 34 computers occurs as a result of an action that originated on that particular branch node 32 computer or leaf node 34 computer which hosts that cloned object, then an object update message is sent up the network node tree 28 to the root node 30 computer where the object update message is processed and then redispatched down the network node tree 28 to the descendant branch node 32 computers and leaf node 34 computers.

The object update message may be nullified and not processed by the root node 30 computer if the object update message has a synchronization counter value which is out of sync with the synchronization counter value of the object contained on the root node 30 computer. An object update message may also be nullified if the distributable object 36 on the root node 30 computer no longer exists, or else the security level of the descendant computer which sent the object update message is not at a level the object determines is adequate for making mutations to the object.

If an object update message is nullified then a nullified update message is dispatched to the descendant computer where the object update message originated. The cloned object on that descendant computer then handles the nullified update message as it is programmed to.

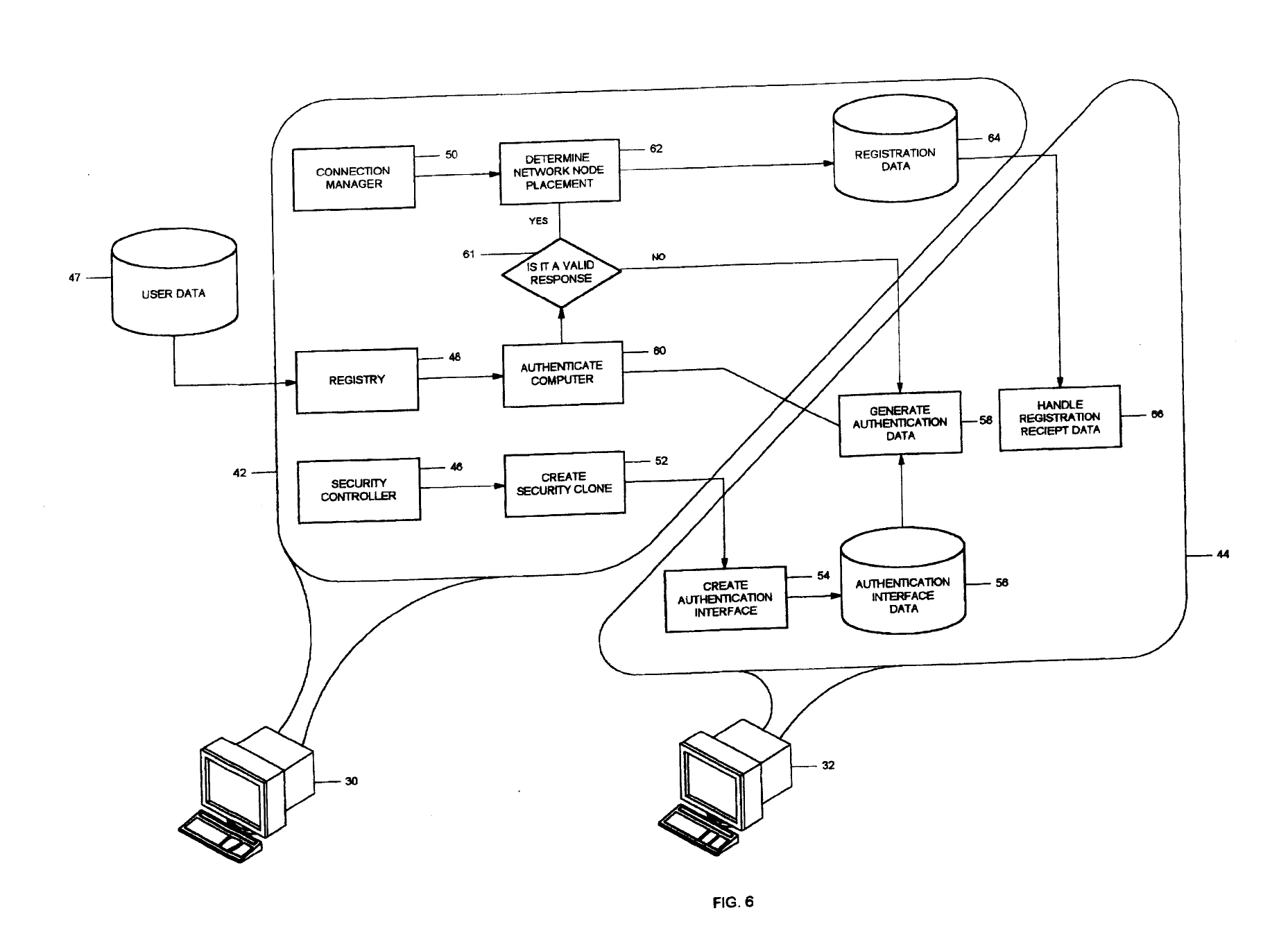

FIG. 6 gives a flowchart of the Authentication 6 and registration 8 process. Part of the steps are done in the root node computer environment 42 and other steps are done in the branch node or leaf node environment 44. The root node computer environment 42 has the security controller 46, root node registry 48 and connection tree manager 50. The first step to utilize the security controller 46 which may use user data 47 to create security controller clone 52 in the root node computer environment 42. The next step is create authentication interface 54 in the branch node environment 44. The authentication interface 54 generates the authorization data 58 which is transmitted through the authentication data connection to the root node environment 42 to authenticate the computer 60 using the authorization criteria from the root node registry 48. If is it a valid authentication response 61, the network node placement is determined 62 using the connection tree manger 50. If it does not have a valid authorization response, it returns back to generate authentication data 56. Registration data 64 is returned to the branch node or leaf node environment 44 to handle the registration response 66.

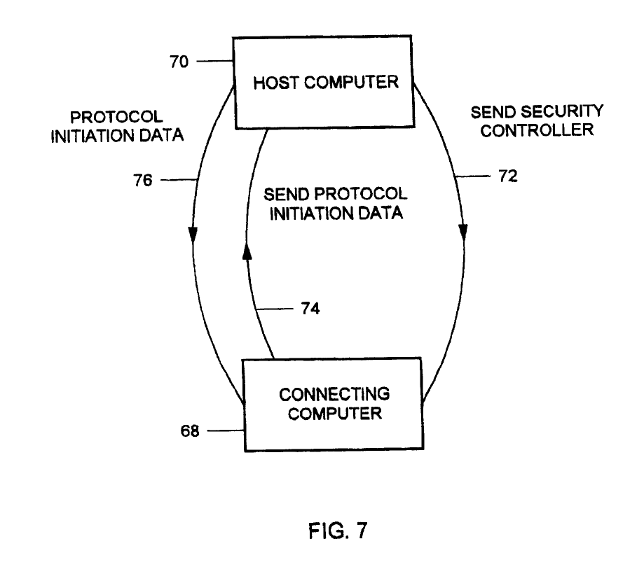

FIG. 7 gives the data flow of the connection 2 and protocol negotiation 4. The connecting computer 68 attempt to establish a link to host computer 70, which is usually the root node 30 computer. The host computer 70 sends a cloned copy 72 of the security controller 46 to the connecting computer 68. Based on the information in the security controller 46 the connecting computer 68 sends the proper protocol initialization data 74 to the host computer 70. If the connection is approved, the host computer 70 sends the proper protocol initialization data 76 back to the connecting computer 68. This protocol negotiation 4 step occurs when a connecting computer 68 first connected to a root node 30 computer for authentication and registration purposes or 28 or when a connecting computer has already been authenticated by a root node server and is reconnecting to another branch node 32 computer in the network node tree 28. Basically before any other communication occurs between a connection of a root node 30 computer and a connecting computer or a branch node computer and a connecting computer 68, the protocol negotiation 4 step must occur to ensure all subsequent messaging is pre-processed according to the rules of the security controller 46. These rules may be encryption rules, compression rules, or any other message processing rule which is configured for the host environment.

The system for object cloning and state synchronization across a network node tree 28 is a process in which the root node 30 and the branch nodes 32 act in combination as a centralized server while reducing the need for a centralized server. The cloning process of the distributable objects 36 through distributable object synchronization 24 keeps the network node tree 28 in sync and while reducing system requirements and the need for excess cache memory. The connection tree manager 50 maintains the location or internet address of all of the nodes in the network node tree 28.

Advantages The previously described version of the present invention has many advantages. The primary advantages are that the objects the client interacts with are real objects and not just an interface to the real object on the host server. The intent is to develop a process that allows a the increase in quality of network connection in the transmission of information back and forth across a network. The present invention adds to the efficiency and productiveness of the process. Using this invention allows client applications to have all of the distributed object synchronization benefits of the prior art, yet distributed objects on the client may act independently of the original remote object's state if they choose, because they are true copies and not just proxy objects of the remote object.

Although the present invention has been described in considerable detail with reference to certain preferred versions thereof, other versions are possible. For example, the steps could be done in different order, the system could be used in an intranet environment, multiple root servers 30 could be used or additional information can be transmitted. Therefore, the point and scope of the appended claims should not be limited to the description of the preferred versions contained herein.

I claim:

1. A distributed object messaging system comprising of:
a process of distributed object synchronization across a network node tree in which the root node and the branch nodes act in combination as a centralized server with
a) a network node tree where a root node computer at the top of the network node tree has a plurality of branch node computers maintaining a network connection to it at any given time,
b) in which each branch node computer may have one or more branch node computers maintaining a network connection to it at any given time,
c) a set of distributable objects, whose origination resides on the root node computer, are cloned and transmitted across the network connection to descendant branch node computers,
d) where if a change is made to the distributable object on the root node computer, that change is redispatched across the network connection to the distributable object residing on each descendant branch node computer,
e) with a security controller in said root node computer environment,
f) with said security controller creating a security controller clone,
g) with said security controller clone creating an authentication interface in the connecting computer,
h) with said authentication interface creating authentication data,
i) with said authentication data is transmitted to the root node,
j) with said root node using the authentication data to authenticate the connecting compute,
k) where if validated the root node returns registration data to the branch node, and
l) where a connection tree manager controls the placement of the connecting computer on the network node tree.

2. The system, as set forth in claim 1, wherein:
said branch nodes and said root nodes may have leaf nodes where said leaf nodes treated like branch nodes by the system.

3. The system, as set forth in claim 1, wherein:
a new peer connecting to an already existing peer on the network can download the synchronized state of these data objects without having to get said data from the original host.

4. The system, as set forth in claim 1, where a connection tree manager instructs all nodes where to connect to the network.

5. The system, as set forth in claim 2, wherein:
a change made to the state of a distributable object on a root node computer, said change is made to each of the distributable objects on all the descendant branch nodes and all of the descendant leaf nodes.

6. The system, as set forth in claim 1, wherein:
a root server is created and said root server forms an I/O channel through a TCP/IP socket.

7. A distributed object messaging system comprising of:
a process of distributed object synchronization across a network node tree in which the root node and the branch nodes act in combination as a centralized server with
a) a network node tree where a root node computer at the top of the network node tree has a plurality of branch node computers maintaining a network connection to it at any given time,
b) in which each branch node computer may have one or more branch node computers maintaining a network connection to it at any given time,
c) a set of distributable objects, whose origination resides on the root node computer, are cloned and transmitted across the network connection to descendant branch node computers,
d) where if a change is made to the distributable object on the root node computer, that change is redispatched across the network connection to the distributable object residing on each descendant branch node computer,
e) with a security controller in said root node computer environment,
f) with said security controller creating a security controller clone,
g) with said security controller clone creating an authentication interface in the connecting computer,
h) with said authentication interface creating authentication data,
i) with said authentication data is transmitted to the root node,
j) with said root node using the authentication data to authenticate the connecting compute,
k) where if validated the root node returns registration data to the branch node, and
l) where a connection tree manager controls the placement of the connecting computer on the network node tree.

8. The system, as set forth in claim 7, wherein:
said branch nodes and said root nodes may have leaf nodes where said leaf nodes treated like branch nodes by the system.

9. The system, as set forth in claim 7, wherein:
a new peer connecting to an already existing peer on the network can download the synchronized state of these data objects without having to get said data from the original host and where a connection tree manager instructs all nodes where to connect to the network.

10. The system, as set forth in claim 7, wherein:
a root server is created and said root server forms an I/O channel through a TCP/IP socket.
